(19) United States
(12) Patent Application Publication
(10) Pub. No.: US 2022/0277329 A1
(43) Pub. Date: Sep. 1, 2022

(54) SYSTEMS AND METHODS FOR REPOSITIONING VEHICLES IN A RIDE-HAILING PLATFORM

(71) Applicant: Beijing DiDi Infinity Technology and Development Co., Ltd., Beijing (CN)

(72) Inventors: Shuaiji LI, SAN JOSE, CA (US); Yan JIAO, SUNNYVALE (CN); Zhiwei QIN, SAN JOSE, CA (US)

(21) Appl. No.: 17/187,405

(22) Filed: Feb. 26, 2021

Related U.S. Application Data
(63) Continuation of application No. 17/186,935, filed on Feb. 26, 2021.

(51) Int. Cl. G06Q 30/02; G08G 1/00; G06N 3/04

(52) U.S. Cl. CPC G06Q 30/0205; G08G 1/202; G06N 3/0445

(57) ABSTRACT

This disclosure describes systems and methods for repositioning vehicles. An exemplary method includes obtaining a plurality of first signals corresponding to a vehicle and a plurality of second signals corresponding to supply-demand statuses in a plurality of neighboring areas of the vehicle; inputting the plurality of first and second signals into a trained neural network and obtaining, from the trained neural network, a plurality of action values for repositioning the vehicle to the plurality of neighboring areas respectively; determining, based on the plurality of action values, a plurality of probabilities for repositioning the vehicle to the plurality of neighboring areas respectively; determining, according to the plurality of probabilities, one of the plurality of neighboring areas for the vehicle to reposition to; and transmitting a signal to a computing device associated with the vehicle to reposition the vehicle to the one determined neighboring area.

### CROSS-REFERENCE TO RELATED APPLICATION

This application is a continuation of U.S. patent application Ser. No. 17/186,935, filed on Feb. 26, 2021, entitled “SYSTEMS AND METHODS FOR REPOSITIONING VEHICLES IN A RIDE-HAILING PLATFORM”. The entirety of the aforementioned application is incorporated herein by reference.

### TECHNICAL FIELD

The disclosure relates generally to repositioning vehicles via a ride-hailing platform, specifically, repositioning mobility-on-demand (MoD) vehicles with deep reinforcement learning.

### BACKGROUND

As urban populations continue to grow in the world's largest markets, the current modes of transportation are increasingly insufficient to cope with the growing and changing demand. The digital platforms offer possibilities of much more efficient on-demand mobility by leveraging more global information and real-time supply-demand data. Auto industry experts expect that ride-hailing apps would eventually make individual car ownership optional, leading towards subscription-based services and shared ownership.

Vehicle repositioning is one of the major levers (along with order dispatching) to improve the system efficiency of MoD platforms by automatically aligning supply and demand better in both spatial and temporal spaces. Vehicle repositioning has a direct influence on driver-side metrics and is important to reduce driver idle time and increase the overall efficiency of an MoD system, by proactively deploying idle vehicles to a specific location in anticipation of future demand at the destination or beyond. As such, repositioning decisions will affect how well future orders can be served.

### SUMMARY

Various embodiments of the specification include, but are not limited to, systems, methods, and non-transitory computer-readable media for repositioning vehicles in ride-hailing platforms.

In some embodiments, a computer-implemented method comprises obtaining, by one or more computing devices, a plurality of first signals corresponding to a vehicle and a plurality of second signals corresponding to supply-demand statuses in a plurality of neighboring areas of the vehicle, wherein the plurality of first signals comprise a current time, a current location of the vehicle, and features of the vehicle, and each of the supply-demand statuses corresponds to a supply and a demand in a corresponding neighboring area; inputting, by the one or more computing devices, the plurality of first and second signals into a trained neural network and obtaining, from the trained neural network, a plurality of action values for repositioning the vehicle to the plurality of neighboring areas respectively; determining, by the one or more computing devices based on the plurality of action values, a plurality of probabilities for repositioning the vehicle to the plurality of neighboring areas respectively; determining, by the one or more computing devices according to the plurality of probabilities, one of the plurality of neighboring areas for the vehicle to reposition to; and transmitting, by the one or more computing devices, a signal to a computing device associated with the vehicle to reposition the vehicle to the one determined neighboring area.

In some embodiments, the method further comprises: training a neural network using a state-action-reward-state-action (SARSA) framework based on a plurality of historical trajectories of one or more historical vehicles, historical supply-demand statuses in a plurality of neighboring areas of the one or more historical vehicles, and a plurality of actual action values based on historical data to obtain the trained neural network.

In some embodiments, each of the plurality of historical trajectories corresponds to a historical vehicle, spans across a plurality of points in time, and comprises a set of states at each of the plurality of points in time, and the set of states comprises a historical time, a historical location, one or more historical features of the historical vehicle, and a supply-demand status in a historical area in which the historical vehicle was located.

In some embodiments, the training comprises: for each of the plurality of historical trajectories, sequentially feeding the sets of states of the each historical trajectory and the corresponding historical supply-demand status in the plurality of neighboring areas of the historical vehicle to a neural network to obtain a predicted action value; and training the neural network based on the predicted action value and one of the plurality of actual action values.

In some embodiments, the determining the plurality of probabilities for repositioning the vehicle to the plurality of neighboring areas comprises: inputting the plurality of action values into a softmax layer of the neural network to obtain a plurality of probabilities.

In some embodiments, the plurality of first signals further comprise: a supply-demand status at the current location of the vehicle.

In some embodiments, the plurality of features of the vehicle comprise at least one of the following: vehicle capacity, manufacturer, year, and model.

In some embodiments, each of the plurality of action values respectively corresponds to a predicted reward for repositioning the vehicle to a corresponding neighboring area.

In some embodiments, the neural network comprises an attention module, and the method further comprises: for a corresponding neighboring area, determining, through the attention module, a score based on a first supply-demand vector representing the supply-demand status of the current location and a second supply-demand vector representing the supply-demand status in the corresponding neighboring area; applying the score to the second supply-demand vector to obtain a weighted supply-demand vector; and generating a weighted supply-demand context vector based on the plurality of weighted supply-demand vectors respectively corresponding to the plurality of neighboring areas.

In some embodiments, the method further comprises: performing cerebellar embedding on one or more of the plurality of first signals to obtain one or more embedded first signals; feeding the one or more embedded first signals to a first Multi-Layer Perceptron (MLP) to obtain a first output; concatenating the first output with the weighted supply-demand context vector to obtain a second output; and feeding the second output into a second MLP to obtain the plurality of action values.

In some embodiments, the supply-demand status includes a ratio of the supply to the demand, the supply corresponds to a number of idle vehicles providing transportation services, and the demand corresponds to a number of pending orders for transportation.

In some embodiments, the determining one of the plurality of neighboring areas for the vehicle to reposition to comprises: performing unequal probability sampling from the plurality of neighboring areas based on the plurality of probabilities to obtain one sampled area.

According to another aspect, a system for vehicle repositioning is described. The system comprises one or more processors and one or more non-transitory computer-readable memories coupled to the one or more processors. The one or more non-transitory computer-readable memories store instructions that, when executed by the one or more processors, cause the system to perform operations comprising: obtaining a plurality of first signals corresponding to a vehicle and a plurality of second signals corresponding to supply-demand statuses in a plurality of neighboring areas of the vehicle, wherein the plurality of first signals comprise a current time, a current location of the vehicle, and features of the vehicle, and each of the supply-demand statuses corresponds to a supply and a demand in a corresponding neighboring area; inputting the plurality of first and second signals into a trained neural network and obtaining, from the trained neural network, a plurality of action values for repositioning the vehicle to the plurality of neighboring areas respectively; determining, based on the plurality of action values, a plurality of probabilities for repositioning the vehicle to the plurality of neighboring areas respectively; determining, according to the plurality of probabilities, one of the plurality of neighboring areas for the vehicle to reposition to; and transmitting a signal to a computing device associated with the vehicle to reposition the vehicle to the one determined neighboring area.

According to yet another aspect, a non-transitory computer-readable storage medium for vehicle repositioning is described. The non-transitory computer-readable storage medium stores instructions that, when executed by one or more processors, cause the one or more processors to perform operations comprising: obtaining a plurality of first signals corresponding to a vehicle and a plurality of second signals corresponding to supply-demand statuses in a plurality of neighboring areas of the vehicle, wherein the plurality of first signals comprise a current time, a current location of the vehicle, and features of the vehicle, and each of the supply-demand statuses corresponds to a supply and a demand in a corresponding neighboring area; inputting the plurality of first and second signals into a trained neural network and obtaining, from the trained neural network, a plurality of action values for repositioning the vehicle to the plurality of neighboring areas respectively; determining, based on the plurality of action values, a plurality of probabilities for repositioning the vehicle to the plurality of neighboring areas respectively; determining, according to the plurality of probabilities, one of the plurality of neighboring areas for the vehicle to reposition to; and transmitting a signal to a computing device associated with the vehicle to reposition the vehicle to the one determined neighboring area.

According to yet another aspect, another method for vehicle repositioning is described. The method comprises: obtaining, by one or more computing devices, a plurality of first signals corresponding to a vehicle and a plurality of second signals corresponding to supply-demand statuses in a plurality of neighboring areas of the vehicle, wherein the plurality of first signals comprise a current time, a current location of the vehicle, and features of the vehicle, and each of the supply-demand statuses includes a ratio of a supply to a demand in a corresponding neighboring area; inputting, by the one or more computing devices, the plurality of first and second signals into a trained neural network and obtaining, from the trained neural network, a plurality of action values for repositioning the vehicle to the plurality of neighboring areas respectively; determining, by the one or more computing devices, respective supply-demand gaps of the plurality of neighboring areas based on the supply-demand status in the plurality of neighboring areas; updating, by the one or more computing devices, the plurality of action values based on the supply-demand gaps of the plurality of neighboring areas to obtain a plurality of updated action values; determining, by the one or more computing devices according to the plurality of updated action values, one of the plurality of neighboring areas for the vehicle to reposition to; and transmitting, by the one or more computing devices, a signal to a computing device associated with the vehicle to reposition the vehicle to the one determined neighboring area.

In some embodiments, the method further comprises: determining, by the one or more computing devices based on the plurality of updated action values, a plurality of action-probabilities for repositioning the vehicle to the plurality of neighboring areas respectively, wherein the determining one of the plurality of neighboring areas for the vehicle to reposition to according to the plurality of updated action values comprises: performing unequal probability sampling from the plurality of neighboring areas based on the plurality of corresponding action-probabilities to obtain one sampled area for repositioning the vehicle to.

In some embodiments, the determining the plurality of action-probabilities comprises: inputting the plurality of updated action values into a softmax layer to obtain the plurality of action-probabilities.

In some embodiments, the updating the plurality of action values based on the supply-demand gaps of the plurality of neighboring areas comprises: for each of the plurality of neighboring areas, determining whether the corresponding supply-demand gap is greater than a threshold; and in response to the corresponding supply-demand gap being greater than the threshold, performing regularization on an action value corresponding to the each neighboring area based on the supply-demand gap.

In some embodiments, the determining respective supply-demand gaps of the plurality of neighboring areas comprises, for each of the plurality of neighboring areas: obtaining a total number of pending orders for transportation in the each neighboring area at a current time as a demand; obtaining a total number of idle vehicles providing transportation services in the each neighboring area at the current time as a supply; and determining a supply-demand gap of the each neighboring area based on a difference between the supply and the demand in the each neighboring area.

In some embodiments, the method further comprises: in response to the supply being equal to or greater than the demand, determining the supply-demand gap as a negative value; and in response to the supply being less than the demand, determining the supply-demand gap as a positive value.

In some embodiments, the plurality of neighboring areas comprise the current location of the vehicle.

In some embodiments, the method further comprises: training the neural network using a state-action-reward-state-action (SARSA) framework based on a plurality of historical trajectories of one or more historical vehicles, historical supply-demand statuses of a plurality of neighboring areas of the one or more historical vehicles, and a plurality of actual action values learned from historical data.

In some embodiments, each of the plurality of historical trajectories of a historical vehicle spans across a plurality of points in time, and comprises a set of states at each of the plurality of points in time, and the set of states comprises a historical time, a historical location, one or more historical features of the historical vehicle, and a supply-demand status of a historical area in which the historical vehicle was located.

In some embodiments, the training comprises: for each of the plurality of historical trajectories of the historical vehicle, sequentially feeding the sets of states of the each historical trajectory and the corresponding historical supply-demand status of the plurality of neighboring areas of the historical vehicle to a neural network to obtain an predicted action value; training the neural network based on the predicted action value and one of the plurality of actual action values learned from the historical data.

According to yet another aspect, another system for vehicle repositioning is described. The system comprises one or more processors and one or more non-transitory computer-readable memories coupled to the one or more processors. The one or more non-transitory computer-readable memories store instructions that, when executed by the one or more processors, cause the system to perform the method described above.

According to yet another aspect, another non-transitory computer-readable storage medium for vehicle repositioning is described. The non-transitory computer-readable storage medium stores instructions that, when executed by one or more processors, cause the one or more processors to perform the method described above.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the specification. It is to be understood that the foregoing general description and the following detailed description are exemplary and explanatory only, and are not restrictive of the specification, as claimed.

### BRIEF DESCRIPTION OF THE DRAWINGS

Non-limiting embodiments of the specification may be more readily understood by referring to the accompanying drawings in which:

FIG. 1A illustrates an exemplary system for ride order dispatching and vehicle repositioning, in accordance with various embodiments.

FIG. 1B illustrates an exemplary system for ride order dispatching and vehicle repositioning, in accordance with various embodiments.

FIG. 2 illustrates an exemplary scenario for vehicle repositioning, in accordance with various embodiments.

FIG. 3A illustrates an exemplary diagram of a neural network for learning reposition action values, in accordance with various embodiments.

FIG. 3B illustrates an exemplary diagram for making reposition decisions using a neural network, in accordance with various embodiments.

FIG. 4A illustrates an exemplary method for repositioning vehicles in a ride-hailing platform, in accordance with various embodiments.

FIG. 4B illustrates an exemplary method for repositioning vehicles in a ride-hailing platform, in accordance with various embodiments.

FIG. 5A illustrates an exemplary system for repositioning vehicles in a ride-hailing platform, in accordance with various embodiments.

FIG. 5B illustrates another exemplary system for repositioning vehicles in a ride-hailing platform, in accordance with various embodiments.

FIG. 6 illustrates a block diagram of an exemplary computer system in which any of the embodiments described herein may be implemented.

### DETAILED DESCRIPTION

Non-limiting embodiments of the present specification will now be described with reference to the drawings. Particular features and aspects of any embodiment disclosed herein may be used and/or combined with particular features and aspects of any other embodiment disclosed herein. Such embodiments are by way of example and are merely illustrative of a small number of embodiments within the scope of the present specification. Various changes and modifications obvious to one skilled in the art to which the present specification pertains are deemed to be within the spirit, scope, and contemplation of the present specification as further defined in the appended claims.

Ride-hailing platforms may include online or application-based platforms that allow users to hire a personal driver. They connect private-hire vehicle drivers with platform users who need a ride. To at least address the issues associated with vehicle management in a ride-hailing platform discussed in the background section, the disclosure provides a framework that is scalable and directly optimizes the vehicle repositioning efficiency across temporal and spatial dimensions. The framework may be self-improving by training on the data it generates during operations, which may be made possible through the use of deep reinforcement learning and through iteratively learning and planning on the spatial-temporal effect of vehicle fleet management.

There are generally two scenarios for vehicle repositioning decisions: in small or in large fleets. Both have their specific use cases. In the small-fleet scenario, the objective may include learning an optimal policy that maximizes an individual driver's cumulative income rate, measured by income-per-hour (IPH). This scenario can target, for example, drivers who are new to an MoD platform to help them quickly ramp up by providing learning-based idle-time cruising strategies. This has a significant positive impact on driver satisfaction and retention. Such a program can also be used as a bonus to incentivize high-quality service that improves passenger ridership experience. In the large-fleet scenario, the problem becomes more intriguing as more factors need to be considered when repositioning vehicles. In a large fleet, the number of vehicles to be repositioned tends to be massive. If the focus is only on each driver's cumulative income rate, the repositioning strategy may order a large amount of similarly situated vehicles (e.g., with similar features) to reposition to the same target area, which may cause an “over-reaction” phenomenon, for example, repositioning too many idle vehicles to a single high-demand spot. This “over-reaction” phenomenon may significantly disturb the supply-demand balances (e.g., a balance between available drivers/vehicles and pending transportation orders) in both the origin area and the target area, and make the overall system unstable/unpredictable. For these reasons, an ideal repositioning strategy for a large fleet may target optimizing the IPH at a group level. To do this, various factors are required to be considered, such as competitions among drivers, supply-demand status in a current area in which a vehicle is located, as well as supply-demand status in the neighboring areas, and may implement various mechanisms to mitigate the undesirable effect caused by potential large scale migrations of similarly situated vehicles.

In some embodiments, a vehicle repositioning framework is designed to combine offline batch reinforcement learning (RL) and decision-time planning for guiding vehicle repositioning. The repositioning problem is modeled within a semi-Markov decision process (semi-MDP) framework, which optimizes a long-term cumulative reward (e.g., daily income rate) and models the impact of temporally extended action (repositioning movements) on the long-term objective through state transitions along with a policy. In some embodiments, a state value function is learned using tailored spatiotemporal deep neural networks trained within a batch RL framework with dual policy evaluation. The state value function is then used with learned knowledge about the environment dynamics to develop a value-based policy search algorithm for real-time vehicle repositioning.

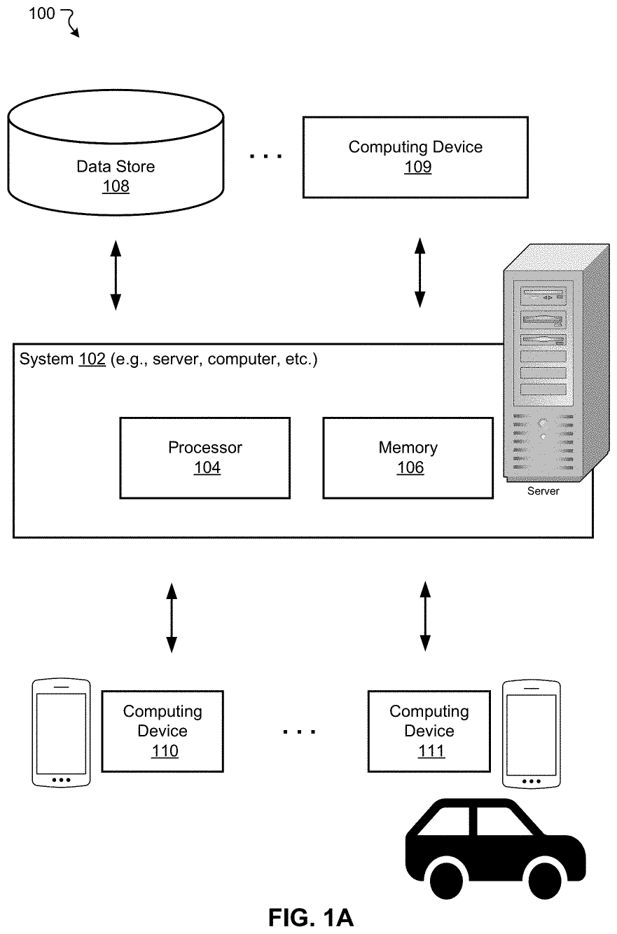

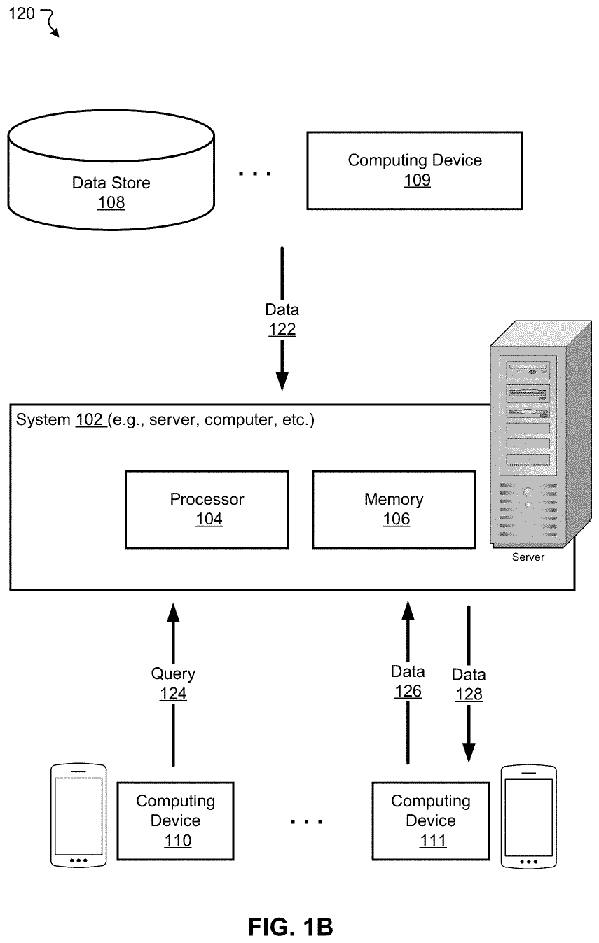

FIG. 1A illustrates an exemplary system 100 for ride order dispatching and vehicle repositioning, in accordance with various embodiments. The operations shown in FIG. 1A and presented below are intended to be illustrative. As shown in FIG. 1A, the exemplary system 100 may comprise at least one computing system 102 that includes one or more processors 104 and one or more memories 106. The memory 106 may be non-transitory and computer-readable. The memory 106 may store instructions that, when executed by the one or more processors 104, cause the one or more processors 104 to perform various operations described herein. The system 102 may be implemented on or as various devices such as mobile phones, tablets, servers, computers, wearable devices (smartwatches), etc. The system 102 above may be installed with appropriate software (e.g., platform program, etc.) and/or hardware (e.g., wires, wireless connections, etc.) to access other devices of the system 100.

The system 100 may include one or more data stores (e.g., a data store 108) and one or more computing devices (e.g., a computing device 109) that are accessible to the system 102. In some embodiments, the system 102 may be configured to obtain data (e.g., training data such as location, time, and fees for multiple historical vehicle transportation trips) from the data store 108 (e.g., a database or dataset of historical transportation trips) and/or the computing device 109 (e.g., a computer, a server, or a mobile phone used by a driver or passenger that captures transportation trip information such as time, location, and fees). The system 102 may use the obtained data to train a model for dispatching shared rides through a ride-hailing platform. The location may be transmitted in the form of GPS (Global Positioning System) coordinates or other types of positioning signals. For example, a computing device with GPS capability and installed on or otherwise disposed in a vehicle may transmit such location signal to another computing device (e.g., a computing device of the system 102).

The system 100 may further include one or more computing devices (e.g., computing devices 110 and 111) coupled to the system 102. The computing devices 110 and 111 may comprise devices such as cellphones, tablets, in-vehicle computers, wearable devices (smartwatches), etc. The computing devices 110 and 111 may transmit or receive data to or from the system 102.

In some embodiments, the system 102 may implement an online information or service platform. The service may be associated with vehicles (e.g., cars, bikes, boats, airplanes, etc.), and the platform may be referred to as a vehicle platform (alternatively as service hailing, ride-hailing, or ride order dispatching platform). The platform may accept requests for transportation, identify vehicles to fulfill the requests, arrange for passenger pick-ups, and process transactions. For example, a user may use the computing device 110 (e.g., a mobile phone installed with a software application associated with the platform) to request a transportation trip arranged by the platform. The system 102 may receive the request and relay it to various vehicle drivers (e.g., by posting the request to a software application installed on mobile phones carried by the drivers). Each vehicle driver may use the computing device 111 (e.g., another mobile phone installed with the application associated with the platform) to accept the posted transportation request, obtain pick-up location information, and receive repositioning instructions. Fees (e.g., transportation fees) can be transacted among the system 102 and the computing devices 110 and 111 to collect trip payment and disburse driver income. Some platform data may be stored in the memory 106 or retrievable from the data store 108 and/or the computing devices 109, 110, and 111. For example, for each trip, the location of the origin and destination (e.g., transmitted by the computing device 110), the fee, and the time can be obtained by the system 102.

The system 100 may include one or more data stores (e.g., a data store 108) and one or more computing devices (e.g., a computing device 109) that are accessible to the system 102. In some embodiments, the system 102 may be configured to obtain data (e.g., training data such as location, time, and fees for multiple historical vehicle transportation trips) from the data store 108 (e.g., a database or dataset of historical transportation trips) and/or the computing device 109 (e.g., a computer, a server, or a mobile phone used by a driver or passenger that captures transportation trip information such as time, location, and fees). The system 102 may use the obtained data to train the algorithm for ride order dispatching and vehicle repositioning. The location may comprise GPS (Global Positioning System) coordinates of a vehicle.

In some embodiments, the system 102 and the one or more of the computing devices (e.g., the computing device 109) may be integrated into a single device or system. Alternatively, the system 102 and the one or more computing devices may operate as separate devices. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. Although the system 102 and the computing device 109 are shown as single components in this figure, it is appreciated that the system 102 and the computing device 109 can be implemented as single devices or multiple devices coupled together. The system 102 may be implemented as a single system or multiple systems coupled to each other. In general, the system 102, the computing device 109, the data store 108, and the computing device 110 and 111 may be able to communicate with one another through one or more wired or wireless networks (e.g., the Internet) through which data can be communicated.

FIG. 1B illustrates an exemplary system 120 for ride order dispatching and vehicle repositioning, in accordance with various embodiments. The operations shown in FIG. 1B and presented below are intended to be illustrative. In various embodiments, the system 102 may obtain data 122 (e.g., training data such as historical data) from the data store 108 and/or the computing device 109. The historical data may comprise, for example, historical vehicle trajectories and corresponding trip data such as time, origin, destination, fee, etc. The obtained data 122 may be stored in the memory 106. The system 102 may learn or extract various information from the historical data, such as supply-demand of an area and its neighboring areas, short-term and long-term rewards for repositioning one or more vehicles (also called observed rewards), etc. The system 102 may train a model with the obtained data 122.

In some embodiments, the computing device 110 may transmit a query 124 to the system 102. The computing device 110 may be associated with a passenger seeking a carpool transportation ride. The query 124 may comprise information such as current date and time, trip information (e.g., origin, destination, fees), etc. In the meanwhile, the system 102 may have been collecting data 126 from a plurality of computing devices such as the computing device 111. The computing device 111 may be associated with a driver of a vehicle described herein (e.g., a taxi, a vehicle providing ride-hailing or ride-sharing services). The data 126 may comprise information such as a current location of the vehicle, a current time, an on-going trip (origin, destination, time, fees) associated with the vehicle, etc. That is, the system 102 have access to the demand (e.g., the queries 124 from passengers seeking rides) and the supply (e.g., the data 126 collected from vehicles in service) of geological regions in real-time. These data may be used as basis to make order-dispatching assignments and vehicle repositioning decisions.

In some embodiments, when making the order-dispatching assignments and vehicle repositioning decisions, the system 102 may send data 128 to the computing device 111 or one or more other devices. The data 128 may comprise an instruction signal or recommendation for an action, such as re-positioning to another location, accepting a new order (including, for example, origin, destination, fee), etc. In one embodiment, the vehicle may be autonomous, and the data 128 may be sent to an in-vehicle computer, causing the in-vehicle computer to send instructions to various components (e.g., motor, steering component) of the vehicle to proceed to a location to pick up a passenger for the assigned transportation trip.

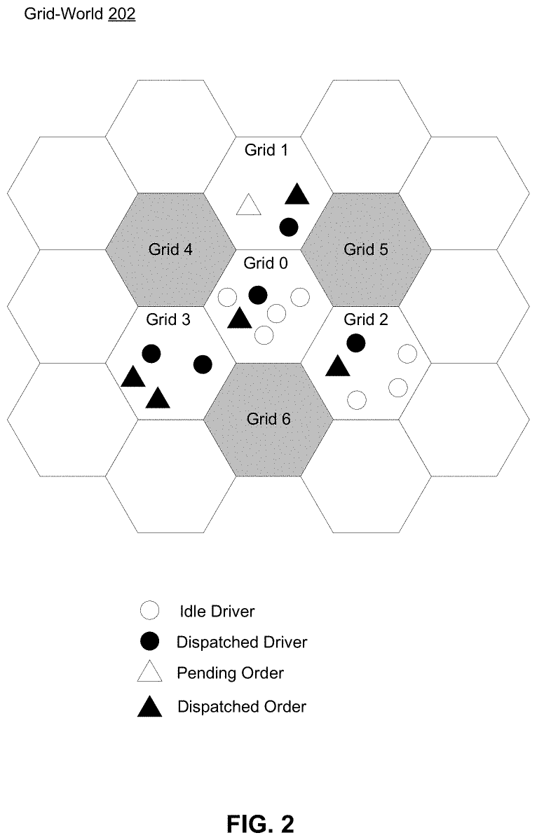

FIG. 2 illustrates an exemplary scenario for vehicle repositioning, in accordance with various embodiments. The grid-world 202 shown in FIG. 2 is intended to represent a vehicle fleet, either a small fleet (e.g., vehicles in a community, a campus, a zip code) or a large fleet (e.g., vehicles in a city, a state, a nation). The grid-world 202 includes a plurality of grid cells, such as grids 0-3, each representing the smallest unit area for repositioning vehicles. Here, the “smallest unit area” may be defined by the ride-hailing platform, such as an artificially drawn hexagon region in a geological area. In some embodiments, vehicles in grid 0 may be repositioned to its neighboring grids (including grids 1-3 that are available for repositioning and the grids 4-6 that are not available for repositioning), or staying in grid 0 (e.g., staying is a special case of repositioning). For illustrative purposes, grids 1-3 are taken as examples to show how a repositioning destination is selected, and grids 4-6 are presumed unavailable (e.g., areas are under construction or without rider traffic). The white dots in FIG. 2 refer to idle vehicles (those being repositioned), black dots refer to dispatched vehicles (those serving orders), white triangles refer to pending orders from riders, and black triangles refer to dispatched rider orders (i.e., the orders being served). In the following description, the term “grid” is used to represent an area or a region in the fleet.

To achieve a better long-term return performance than existing vehicle repositioning solutions, the embodiments described herein include various representations of the supply-demand of a grid and its neighboring grids. In some embodiments, the supply-demand status of a grid may be represented in various forms based on the number of idle vehicles (i.e., supply) and the number of pending orders during a preset period of time (i.e., demand). For example, the supply-demand status may be represented as a supply-demand gap (e.g., a difference between the supply and demand), a supply-demand ratio (e.g., the supply to the demand or the demand to the supply), or another suitable representation. In some embodiments, the supply-demand of the grid may be represented as a scalar value or a vector. In some embodiments, the vector may include a plurality of supply-demand values of one grid spanning across a plurality of time periods (e.g., every 1 minute for the past 10 minutes). Compared to a scalar value representation, a vector representation of the supply-demand of a grid may include richer information such as supply-demand trends within the grid. For example, the vector may include multiple scalar values and each scalar value refers to the supply-demand within a 1-minute window. The supply-demand of a grid may be represented in other forms, depending on the implementation.

For simplicity, it is presumed that the supply-demand of a grid is represented as a scalar value, determined by supply (e.g., the number of idle vehicles) minus demand (e.g., the number of pending orders). With this presumption, the closer the scalar value is towards 0, the more balanced supply-demand a grid has. As shown in the scenario in FIG. 2, among grids 0-3, grid 0 has one dispatched vehicle serving one dispatched order and four idle vehicles, thus grid 0 has a supply-demand value of 4 (e.g., over-supplied). Similarly, grid 1 has a supply-demand value of −1 (e.g., under-supplied), grid 2 has a supply-demand value of 3 (e.g., over-supplied), and grid 3 has a supply-demand value of 0 (e.g., balanced).

In some embodiments, all the idle vehicles managed by one repositioning system may be given reposition instructions based on a plurality of first signals corresponding to the vehicle and a plurality of second signals corresponding to supply-demand status in a plurality of neighboring areas of the vehicle. The first signals may include various features of the vehicle, a current time, a current location, etc. The second signals may include environment dynamics, such as supply-demand of the current grid and its neighboring grids. For example, a server of a ride-hailing platform may predict action values for repositioning a vehicle from one place to another. Such action value may include a short-term reward for the individual vehicle, a long-term reward for a group of vehicles, a long-term return for the platform, another reward metric, or any combination thereof. In some embodiments, the platform may train a machine learning model based on historical data to predict the action values of repositioning decisions.

As shown in FIG. 2, from the perspective of grid 0, four idle vehicles may receive repositioning instructions determined by a ride-hailing platform server according to the features of the four vehicles and the supply-demand of grid 0 as well as the neighboring/surrounding six grids. Assuming all four idle vehicles share similar features, the action values of repositioning them may be primarily affected by supply-demand conditions in the neighboring grids (including the current grid, e.g., grid 0). As an intuitive solution, for each individual vehicle, the ideal repositioning decision with the highest action value may be to move the vehicle from a high-supply-low-demand grid (e.g., with a high supply-demand value) to a grid with low-supply-high-demand (e.g., with the smallest supply-demand value). In FIG. 2, assuming only grids 0-3 are available for repositioning to, grid 1 has the smallest supply-demand value of −1 in comparison to that of grids 0, 2, and 3. Thus, grid 1 may be the “ideal” destination for repositioning the four vehicles. However, if all four vehicles in grid 0 receive the same repositioning instruction to move from grid 0 to grid 1, it will create an “over-reaction” phenomenon that worsens the supply-demand condition in grid 1.

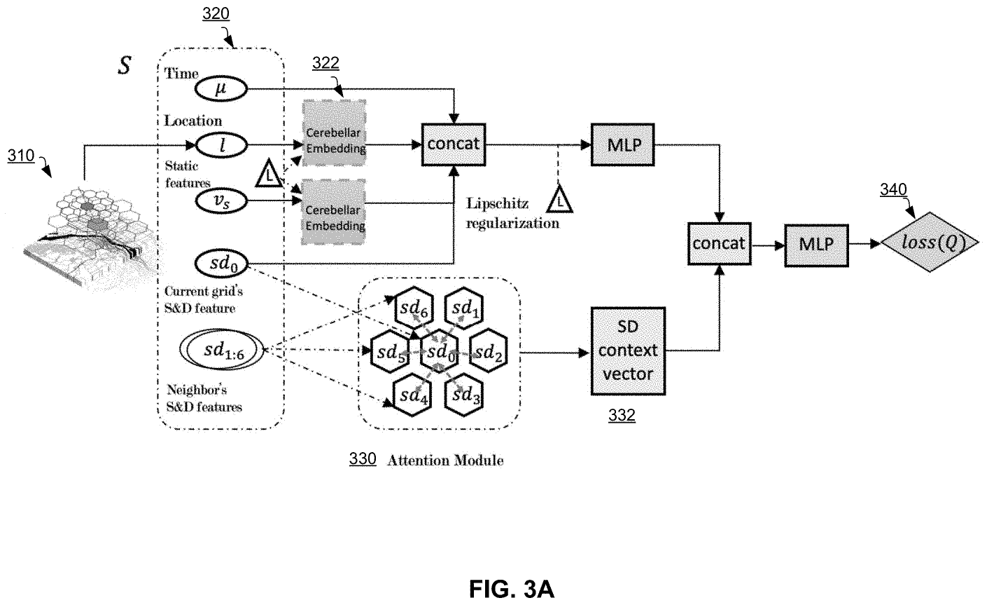

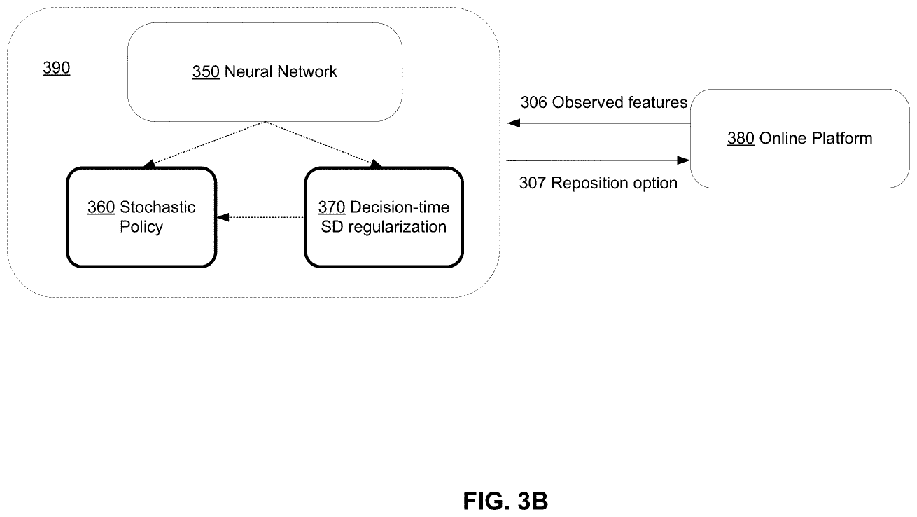

In order to solve the above-identified problem, some embodiments described in this disclosure first train a neural network based on historically observed data to predict action values of repositioning vehicles from one grid to another grid, and then at the decision making phase, adopt a stochastic policy and/or decision-time supply-demand regularization to induce coordination among the vehicles and to be more adaptive to the dynamic nature of the vehicle fleet. More details may refer to the description of FIGS. 3A and 3B. For simplicity and consistency, the term “driver” and “vehicle” are used interchangeably in this disclosure, assuming one driver drives one vehicle at a time and one vehicle is being driven by only one driver at a time. In certain cases involving self-driving vehicles that do not have drivers, the “vehicle” or “driver” means the self-operating vehicle, and the rewards refer to the rewards generated by the “vehicle” for its owner.

FIG. 3A illustrates an exemplary diagram of a neural network for learning reposition action values, in accordance with various embodiments. The structure and data flow of the neural network shown in FIG. 3A are intended to be illustrative and may be configured differently depending on the implementation.

### Vehicle Repositioning Problem Formulation

In a ride-hailing platform, vehicle repositioning may adjust supply-demand balances in the fleet to facilitate more efficient order dispatching/matching. Order dispatching/matching takes place in a batch fashion typically with a time window of a few seconds. The trip fee is collected upon the completion of the trip. After dropping off a passenger, the vehicle becomes idle. If the idle time exceeds a threshold of L minutes (e.g., five to ten minutes), the vehicle performs repositioning by cruising to a specific destination, incurring a non-positive cost. If the vehicle is to stay around the current location, it may stay for L minutes before another repositioning is triggered. During the course of repositioning, the vehicle is still eligible for order assignment. The objective of repositioning is to maximize income efficiency (or income rate), measured by income per (online) hour (IPH). This metric may be measured at an individual driver's level or an aggregated level over a group of drivers. Thus, vehicle repositioning is a sequential decision problem in which the current reposition actions affect the future income of the vehicles.

In some embodiments, in order to predict action values of different repositioning options, a neural network may be trained based on historical data to learn a hidden relationship between a plurality of input features (also called state) and observed rewards (also called reward). The historical data may include a plurality of historical trajectories of one or more historical vehicles, historical supply-demand statuses of a plurality of neighboring areas of the one or more historical vehicles, and a plurality of actual action values learned from historical data. For example, each of the plurality of historical trajectories of a historical vehicle spans across a plurality of points in time, and includes a set of states at each of the plurality of points in time, and the set of states includes a historical time, a historical location, one or more historical features of the historical vehicle, and a supply-demand status of a historical area in which the historical vehicle was located.

In some embodiments, each trajectory of a vehicle may be modeled by a semi-Markov decision process (MDP) framework, with a software agent (the agent) representing the vehicle. The MDP framework may be defined by a plurality of key components, such as state, action option, reward, and transition, which are defined as below.

State: in some embodiments, the state of the agent (e.g., a vehicle), denoted as s, may include spatiotemporal information of location/and time t, features, additional supply-demand contextual features, other suitable information, or any combination thereof. In some embodiments, the supply-demand contextual features may also be referred to as supply-demand statuses of the plurality of neighboring areas of the agent. The “neighboring areas” are the candidates for repositioning the agent. For this reason, the “neighboring areas” may include the current location of the vehicle as well as the spatially neighboring locations of the vehicle. In some embodiments, each supply-demand status of a location in the context of “state” may include a supply-demand ratio determined by the supply to the demand at the location.

Action Option: in some embodiments, eligible actions for the agent to take include both vehicle repositioning and order fulfillment (as a result of order dispatching). These actions are temporally extended, so they are options in the context of a semi-MDP and are denoted as o. In some embodiments, a basic repositioning action is to go towards a destination in one of a plurality of neighboring grids or staying in the current grid in which the agent is currently located. In some embodiments, if the entire grid is represented as a gridded world, each grid may be denoted as a hexagon grid cell (or another shape). In the following description, a single action option denoted as o_{d} may represent all the dispatching options, (e.g., moving to one of the neighboring hexagon grid cells or staying in the current hexagon grid cell). The time duration for performing a repositioning may be denoted as rₒ.

Reward: in some embodiments, a price/reward of a trip corresponding to an order dispatching action is defined as pₒ>0, and the cost of a repositioning action option is defined as cₒ≤0. With these definitions, an immediate reward of a transition is r=cₒ for repositioning and r=pₒ for order fulfillment. The corresponding estimated version of rₒ, pₒ, and cₒ are \hat{r}ₒ,\hat{p}ₒ, and ĉₒ, respectively.

Transition: the transition of the aforementioned agent given a state and a repositioning option is deterministic, while the transition probability for a given dispatching option P(s′ |s, o_{d}) is the probability of a trip going to s′ given s being assigned to the agent.

In some embodiments, an episode of the above-described semi-MDP runs till the end of a day. For example, a state with its time component at midnight is terminal. The semi-MDP is aimed to train a joint policy including a repositioning policy πᵣ and a dispatching policy π_{d}, and the joint policy is denoted as π:=(πᵣ, π_{d}). In the following description, it is assumed the dispatching policy π_{d} is exogenous and already learned, denoted as π_{d0}, and the embodiments are designed to learn the repositioning policy πᵣ. That is, at a decision point in these embodiments, only repositioning options need to be considered. The value function (also called Q-function) in the semi-MDP framework may then be denoted by Q^{π}^{ᵣ} (s, o), with the understanding that it is also associated with the learned π_{d0}. \hat{Q} denotes the approximation of the Q-function. By learning \hat{Q}(s, o) for a particular state s, the agent would be able to determine the best movement (reposition decision) at each decision point. The objective is to maximize a cumulative income rate (IPH), which is a ratio of the total price of a plurality of trips completed during an episode and a total number of online hours logged by a vehicle (individual level) or a group of vehicles (group level). In some embodiments, the individual level IPH for a vehicle x may be defined as

$$p ( x ) := \frac{c ( x )}{h ( x )}$$

where c(.) refers to the total income of the vehicle x over the course of an episode, and h(.) refers to the total online hours of the vehicle. In some embodiments, the group-level IPH for a group X of vehicles may be similarly defined as

$$P ( X ) := \frac{{\sum }_{x ∈ X} c ( x )}{{\sum }_{x ∈ X} h ( x )} .$$

### Learning Action-Values in a Large Vehicle Fleet

In order to address the problem or mitigate the negative effect of above-mentioned “over-reaction” phenomenon, global coordination among a group of vehicles may be required so that the repositioning does not create additional supply-demand imbalance.

To achieve this goal, in some embodiments, supply-demand status of repositioning destinations are taken into consideration when determining action-values for repositioning to the destinations. For example, the process may include: obtaining, by one or more computing devices, a plurality of first signals corresponding to a vehicle and a plurality of second signals corresponding to supply-demand status in a plurality of neighboring areas of the vehicle; inputting, by the one or more computing devices, the plurality of first and second signals into a trained neural network Q(s, o) and obtaining, from the trained neural network, a plurality of action values for repositioning the vehicle to the plurality of neighboring areas respectively.

In some embodiments, the neural network Q(s, o) (also called value function) may be trained by using a deep State-Action-Reward-State-Action (SARSA) algorithm. SARSA algorithm is for learning a Markov decision process policy, used in the reinforcement learning (RL) area of machine learning. It is similar to the typical Q-learning based RL. The difference is that SARSA is an on-policy RL learning while Q-learning is an off-policy RL. On-policy RL learns about the return observed when following some specific policy, π. That is, the return observations are generated according to that policy π Off-policy RL learns about one policy, π₁, while the reward observations are generated by action sequence of another policy, π₂. For Q-learning, the another policy, π2, may refer to a greedy policy. In comparison with an alternative value-based policy search (VPS) algorithm, using SARSA in this particular context (e.g., learning action value based on the state of the vehicle as well as state of the environment) offers at least the following technical advantages: low latency, faster decision-time planning (since there is no requirement for tree search as in VPS), supervised learning with historical data, high accuracy, and most importantly, organic fit for adding supply-demand features as input.

FIG. 3A shows an exemplary workflow of using the trained neural network to predict the action values of repositioning options for a vehicle. In some embodiments, the neural network may include an embedding layer 322, an attention module 330, and an output layer 340.

In some embodiments, the input to the trained neural network may include various features 320 collected from the vehicle fleet 310. These features 320 may include time features (e.g., month, day, time), location features (e.g., GPS coordinates), features (e.g., vehicle capacity, manufacturer, year, model, car seat option). In addition, the input features may also include supply-demand features in a current grid in which the vehicle is located and its neighboring grids. In some embodiments, the entire fleet may be converted into a gridded world, and each grid may be represented as a hexagon grid cell that has six (or another suitable number) neighboring hexagon grid cells. The supply-demand features of the current grid may be referred sd₀, and the supply-demand features of the neighboring grids may be referred to as sd₁˜sd₆. In some embodiments, the supply-demand feature of a grid may be represented as a vector determined by the number of pending orders and the number of idle vehicles to be matched. Including these supply-demand features in the neural network may facilitate characterizing the state of the vehicle and its surrounding environment more accurately, thus allowing for better state representation and responsiveness to changes in the environment.

In some embodiments, one or more of the features 320 may go through the embedding layer 322 to perform cerebellar embedding on these features to obtain one or more embedded first signals. For example, the time feature, the location feature, and the features of the vehicle in FIG. 3A may go through the embedding layer 322 that performs cerebellar embedding to obtain their respective embedded versions. The purpose of performing cerebellar embedding to some of the input features may include obtaining distributed, robust, and generalizable feature representations of the features. In some embodiments, to better ensure the robustness of the neural network against input perturbations, Lipschitz regularization may be employed to control the Lipschitz for the cerebellar embedding layer 322 and the multilayer perceptron (MLP) layers down the pipeline. As shown in FIG. 3A, Lipschitz regularization may be applied to the cerebellar embeddings of the location feature and the features of the vehicle.

In some embodiments, the attention module 330 of the neural network may be configured to: for each of the plurality of neighboring grids (each of sd₀˜sd₆, noted that sd₀ is included), determining, through the attention module 330, a score based on a first supply-demand vector representing supply-demand of a current grid in which the vehicle is located and a second supply-demand vector representing supply-demand of the each neighboring grid; applying the score to the second supply-demand vector to obtain a weighted supply-demand vector; and generating a weighted supply-demand context vector based on the plurality of weighted supply-demand vectors respectively corresponding to the plurality of neighboring grids. As shown in FIG. 3A, the attention module 330 may assign scores to each pair of supply-demand features including the supply-demand feature of the current grid sd₀ through a softmax function, denoted as αᵢ=softmax(sd₀^{T}W_{α}sdᵢ), where iϵZ (e.g., integers), i=[1 . . . 6] in the example shown in FIG. 3A, and W_{α} is a trainable weight matrix in the attention module 330. The trainable weight matrix may improve the accuracy of the score for each pair of supply-demand features. For example, since sd₀ and sdᵢ are both vectors, a direct dot multiplication of sd₀ and sdᵢ may incorrectly generate a very high score when the two vectors include the same values. However, when a pair of two grids have very similar supply-demand statuses (e.g., both have balanced supply and demand), assigning a high score to the pair may indicate a high chance of repositioning vehicles from one of the two grids to the other one, which may ruin the supply-demand in one or both of the grids. To address this issue, the trainable weight matrix may assign weights to different combinations of pairs of supply-demand features. In some embodiments, the attention module 330 may be designed to cast higher weights into nearby grids possessing a better supply-demand ratio (e.g., a lower supply/demand ratio or a higher demand/supply ratio, indicating high demand but low supply) than the current grid, so that more attention will be given to action destinations with abundant ride requests.

In some embodiments, the scores generated by the attention module 330 may then be used to re-weight the neighboring supply-demand vectors sd₀˜sd₆, and thus obtain a dense and robust supply-demand context vector 332 representation.

In some embodiments, the non-supply-demand features (may include cerebellar embedded versions) and the supply-demand feature of the current grid may be concatenated first, and the concatenated output may go through a Lipschitz regularization before being fed into a first MLP layer. In some embodiments, the output of the first MLP layer and the supply-demand context vector 332 may be concatenated again and then fed into a second MLP. In the output layer 340, the output of the second MLP may be the Q values of repositioning destinations (e.g., when deploying the trained neural network in service) or a loss function, such as mean square error, of the Q values of the repositioning destinations (e.g., when training the neural network).

The workflow shown in FIG. 3A includes the application of the trained neural network. In some embodiments, the neural network may be trained based on historical data. The training process includes a similar process as described above, with the input being features collected from historical trips rather than from the live environment. During the training, the loss(Q) 340 may be determined based on the predicted Q values and the actual rewards observed from the historical data. The loss(Q) 340 may be used for backpropagation and adjust the weights of the neural network so that the further predicted Q values are more close to the observed rewards.

In some embodiments, the training process may include: training the neural network using a state-action-reward-state-action (SARSA) framework based on a plurality of historical trajectories of one or more historical vehicles, historical supply-demand statuses of a plurality of neighboring grids of the one or more historical vehicles, and a plurality of actual action values learned from historical data. Each of the plurality of historical trajectories of a historical vehicle spans across a plurality of points in time, and comprises a set of states at each of the plurality of points in time, and the set of states comprises a historical time, a historical location, one or more historical features of the historical vehicle, and a supply-demand status of a historical grid in which the historical vehicle was located. The training may include: for each of the plurality of historical trajectories of the historical vehicle, sequentially feeding the plurality of sets of states of the each historical trajectory and the corresponding historical supply-demand status of the plurality of neighboring grids of the historical vehicle to a neural network to obtain a predicted action value; training the neural network based on the predicted action value and one of the plurality of actual action values learned from the historical data.

FIG. 3B illustrates an exemplary method for repositioning vehicles in a ride-hailing platform, in accordance with various embodiments. The blocks in FIG. 3B are for illustrative purposes and may be organized in various ways depending on the actual implementation.

A neural network 350 Q (s, o) trained with the method described in FIG. 3A or another suitable training process may predict action values of repositioning options for a vehicle, where the action value generated by Q indicates the reward/quality/score for a vehicle (and/or the ride-hailing platform) in a state s performing a repositioning action o. With a deterministic repositioning policy π(s)=Q^{π}(s, o), vehicles in the same state will be repositioned to the same destination. It may be acceptable when the vehicle fleet is small and the vehicles can be essentially treated independently (as the probability of multiple vehicles being in the same state is small). However, as the size of the fleet increases, it may happen more often that multiple vehicles would come across each other, and the effect of the “over-reaction” phenomenon becomes more severe.

In some embodiments, to mitigate the “over-reaction” effect of directly using the neural network 350, a stochastic policy 360 may be deployed to randomize the predicted action values of repositioning options by adding a softmax layer to the neural network. For example, the softmax layer may be appended to the original output layer of the neural network that generates predicted action values, and become the new output layer of the neural network. The input to the softmax layer may include the predicted action values from the original output layer, and the output from the softmax layer may include a plurality of predicted action probabilities. In other words, the softmax layer may convert a plurality of action values into a plurality of action probabilities for repositioning the vehicle to the plurality of neighboring areas respectively. The action probabilities may follow a Boltzmann distribution. For example, the softmax layer may be defined as

$${( q )}_{k} = \frac{exp ( {q}_{k} )}{{\sum }_{j} exp ( {q}_{j} )} ,$$

∀kϵK, where q refers to a vector of reposition action values predicted by the neural network 350, K refers to the set of eligible repositioning destinations (e.g., repositioning options), exp stands for an expectation operator, and j refers to all the valid index within K. In some embodiments, the softmax layer is implemented as a block of computer programming code.

Applying such stochastic policy 360 in the context of vehicle repositioning context is particularly appealing for at least two reasons. First, negative action values would not be a concern. Since the supply-demand situations in the current and neighboring grids are considered in predicting reposition action values, negative action values may be generated when repositioning a vehicle makes the supply-demand situation in the destination grid worse (e.g., moving to a grid with a higher supply). For a deterministic policy, any negative values will be used directly to determine the action (selecting a repositioning destination), which may cause calculation breakdown (e.g., when the calculation involves multiplication). For a stochastic policy with softmax, however, any negative values will be transformed into values between 0 to 1, so that they can be interpreted as probabilities. This way, the negative values will not cause calculation breakdowns. Second, the vehicle repositioning decisions follow the action distribution 6(q). For example, when there are multiple idle vehicles in the same grid at a given time, the dispatching decisions are determined in proportion to the exponentiated values of the reposition options. In some embodiments, the decisions may be made by sampling the plurality of neighboring grids based on corresponding action probabilities of the neighboring grids to obtain one neighboring grid to reposition the vehicle to. With this stochastic policy 350, a first reposition option with a high reposition value will have a higher probability to be selected and performed, but a second reposition option with a lower reposition value still has a chance (even if it is a lower chance) to be selected and performed, thereby preventing the vehicles in the same state from flooding into the same reposition destination and causing “overreaction.”

Even though the semi-MDP formulation and the corresponding neural network described in FIG. 3A make supply-demand features of destination grids as part of the input, they are still designed from the perspective of a single vehicle, and the input is still heavily weighted on the features associated with the vehicle, such as time, location, and features of an individual vehicle. To further improve the accuracy of predicting action values for repositioning options, the supply-demand features may need to be explicitly incorporated into the prediction process.

In some embodiments, after obtaining action values of repositioning options generated by the above-described trained neural network, the supply-demand gaps at the destinations may be used to perform penalization in a decision-time SD regularization module 370 to update these obtained action values. In some embodiments, the supply-demand gap at a destination may be determined as a difference between the supply and the demand at the destination. It may be noted that in FIG. 3A, the “supply-demand feature” of a destination grid for training and inferencing refers to a supply-demand ratio of the destination. Supply-demand ratio and supply-demand gap are two similar but different concepts: both the ratio and the gap disclose how balanced the supply and the demand are at a location, while the gap further demonstrates an absolute difference between the supply and demand. For example, a busy location and a quiet location may have the same supply-demand ratios (e.g., the supply divided by the demand), but the busy location may have a greater supply-demand gap (e.g., the supply minus the demand).

This process further and explicitly regularizes the reposition action values and/or the action distribution. For example, the repositioning decision-making process may include: determining respective supply-demand gaps of the plurality of neighboring areas based on the supply-demand status in the plurality of neighboring areas; updating the plurality of action values based on the supply-demand gaps of the plurality of neighboring areas to obtain a plurality of updated action values; and determining, according to the plurality of updated action values, one of the plurality of neighboring areas for the vehicle to reposition to. In some cases, the reposition action values may be penalized by the respective destination supply-demand gaps in a linear form.

In some embodiments, the decision-time SD regularization module 370 may be used in conjunction with the stochastic policy 360 described above. For example, after updating the plurality of action values based on the supply-demand gaps of the plurality of neighboring areas to obtain a plurality of updated action values, the stochastic policy 360 may be used to determine a plurality of action-probabilities for repositioning the vehicle to the plurality of neighboring areas respectively based on the plurality of updated action values. Subsequently, the one repositioning destination may be selected by performing unequal probability sampling from the plurality of neighboring areas (including the current area/location of the vehicle) based on the plurality of corresponding action-probabilities to obtain one sampled neighboring area for repositioning the vehicle. Under unequal probability sampling, different neighboring areas may have different probabilities (represented by the action-probabilities) to be selected/sampled. The action-probabilities of the neighboring areas may be proportional to the corresponding updated action-values predicted by the neural network. In some embodiments, the decision-time SD regularization module 370 may be implemented as a software function or API that performs the following described operations.

An exemplary decision-time SD regularization module 370 may be defined as qₖ′:=qₖ+λgₖ,∀kϵK, where qₖ′ refers to the penalized version of the Q value qₖ predicted by the neural network 350, gₖ refers to the supply-demand gap in a destination grid k, and λ refers to a tunable weight parameter. One of the major advantages of the decision-time SD regularization module 370 over the stochastic policy 360 is that it is generally less sensitive to perturbation in the input SD data, which may be dynamic and prone to prediction errors. However, the decision-time SD regularization module 370 and the stochastic policy 360 may be complementary rather than conflicting. Both of them may be implemented on top of the neural network 350. For example, the construction of the stochastic policy 360 may generate an action distribution following Boltzmann distribution, and the SD gap penalty in the decision-time SD regularization module 370 may be multiplicative on the action distribution. That is, the stochastic policy 360 may be constructed first, and the decision-time SD regularization may be applied afterward on the output of the stochastic policy 360. As another example, the decision-time SD regularization module 370 may be applied directly to the predictions generated by the neural network 350 to obtain penalized versions, and then the stochastic policy 360 may be constructed based on the penalized versions of the predicted action values.

In some embodiments, the decision-time SD regularization module 370 may include a penalty threshold trained based on historical data. This penalty threshold defines a threshold on SD gaps, and the action values for destinations with SD gaps greater than this threshold may be penalized. An exemplary process may be defined as qₖ′:=qₖ+λgₖ1_{g}_{ₖ}_{>β}),∀kϵK, where β refers to the threshold on SD gaps, which may be area-specific.

In some embodiments, the neural network 350, the stochastic policy 360, and the decision-time regularization 370, or any combination of thereof may be collectively referred to as a repositioning service 390 to answering queries from a ride-hailing online platform 380. For example, the online platform 380 may submit a request including observed features 306 including various features of a vehicle and the required supply-demand features of grids associated with the vehicle, and receive a reposition action option 307 from the repositioning service 390 to reposition the vehicle.

After one repositioning destination for a vehicle is determined, the repositioning service 370 may transmit a signal to the online platform 380 or directly to the vehicle for the vehicle to reposition to the determined destination. For example, the signal may be directly transmitted to a computing device of the vehicle or a computing device of the vehicle driver.

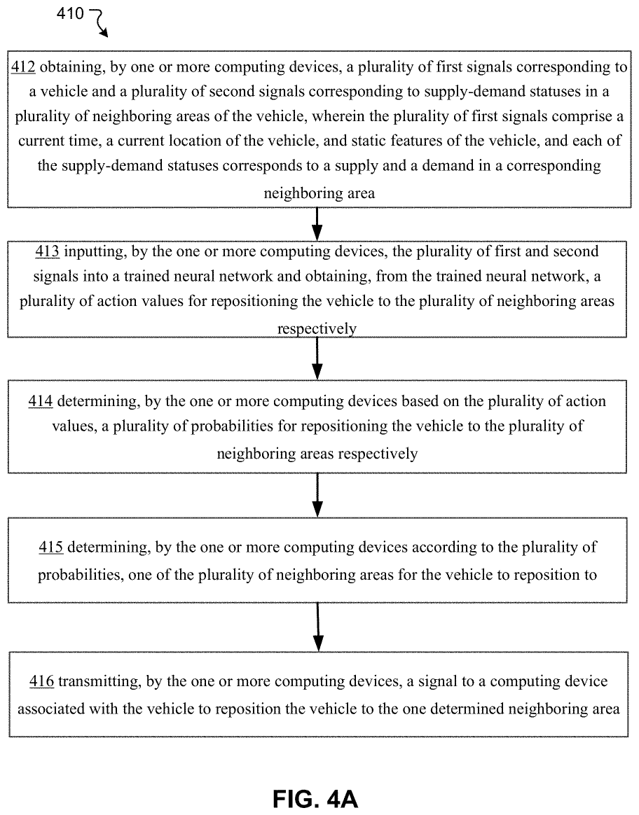

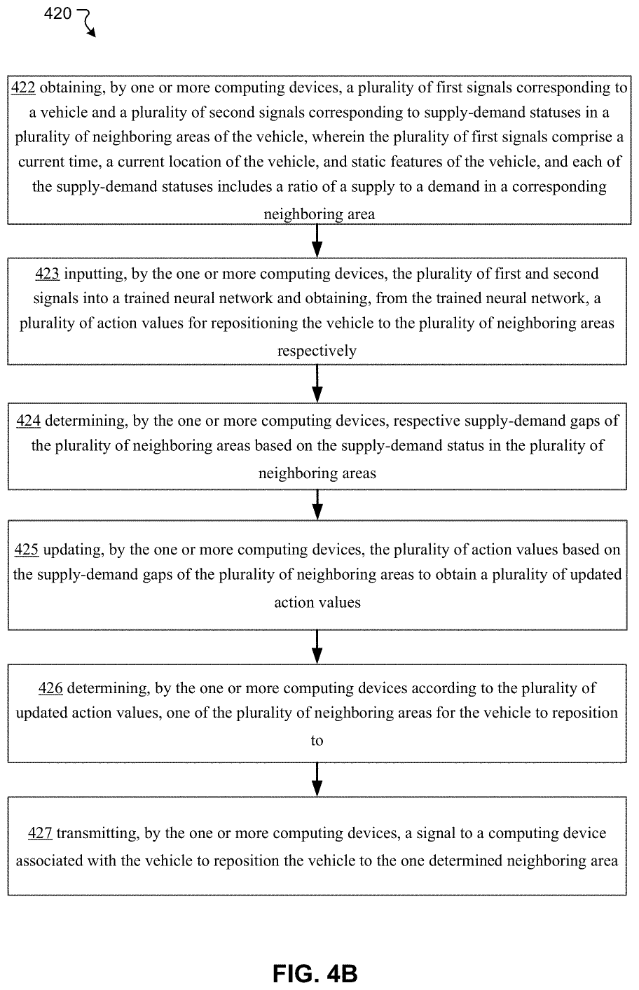

FIG. 4A illustrates an exemplary method 410 for repositioning vehicles in a ride-hailing platform, in accordance with various embodiments. The method 410 may be implemented in an environment shown in FIG. 1A. The method 410 may be performed by a device, apparatus, or system illustrated by FIGS. 1A-3B, such as the system 102. Depending on the implementation, the method 410 may include additional, fewer, or alternative steps performed in various orders or in parallel.

With respect to the method 410 in FIG. 4A, at block 412, a plurality of first signals corresponding to a vehicle and a plurality of second signals corresponding to supply-demand status in a plurality of neighboring areas of the vehicle may be obtained. The plurality of first signals comprise a current time, a current location of the vehicle, and features of the vehicle. In some embodiments, the plurality of first signals corresponding to a vehicle further includes a supply-demand status of a current area in which the vehicle is located. In some embodiments, the plurality of second signals corresponding to supply-demand status in a plurality of neighboring areas includes a supply-demand status of a current area in which the vehicle is located; and supply-demand status of one or more neighboring areas of the vehicle. In some embodiments, the supply-demand features comprises a number of pending for transportation and a number of idle vehicles providing transportation services.

At block 413, the plurality of first and second signals may be input into a trained neural network to obtain a plurality of action values for repositioning the vehicle to the plurality of neighboring areas respectively. In some embodiments, the neural network comprises an attention module, and the method 410 may further includes: for each of the plurality of neighboring areas, determining, through the attention module, a score based on a first supply-demand vector representing supply-demand of a current area in which the vehicle is located and a second supply-demand vector representing supply-demand of the each neighboring area; applying the score to the second supply-demand vector to obtain a weighted supply-demand vector; and generating a weighted supply-demand context vector based on the plurality of weighted supply-demand vectors respectively corresponding to the plurality of neighboring areas. In some embodiments, the method 410 may further include: performing cerebellar embedding on one or more of the plurality of first signals to obtain one or more embedded first signals; feeding the one or more embedded first signals to a first Multi-Layer Perceptron (MLP) to obtain a first output; concatenating the first output with the weighted supply-demand context vector to obtain a second output; feeding the second output into a second MLP to obtain the plurality of action values for repositioning the vehicle to the plurality of neighboring areas respectively.

At block 414, a plurality of probabilities for repositioning the vehicle to the plurality of neighboring areas may be respectively determined based on the plurality of action values. In some embodiments, the determining a plurality of action-probabilities may include inputting the plurality of action values into a softmax layer to obtain the plurality of action-probabilities, wherein the softmax layer is implemented as a block of computer programming code. In some embodiments, the plurality of probabilities follows a Boltzmann distribution.

At block 415, one of the plurality of neighboring areas for the vehicle to reposition to may be determined based on the plurality of probabilities. In some embodiments, the determining one of the plurality of neighboring areas for the vehicle to reposition to according to the plurality of action-probabilities includes: performing unequal probability sampling from the plurality of neighboring areas based on the plurality of corresponding action-probabilities to obtain one sampled area.

At block 416, a signal may be transmitted to a computing device associated with the vehicle to reposition the vehicle to the one determined neighboring area.

In some embodiments, the method 410 may further include: training the neural network using a state-action-reward-state-action (SARSA) framework based on a plurality of historical trajectories of one or more historical vehicles, historical supply-demand statuses of a plurality of neighboring areas of the one or more historical vehicles, and a plurality of actual action values learned from historical data. Each of the plurality of historical trajectories of a historical vehicle spans across a plurality of points in time, and comprises a set of states at each of the plurality of points in time, and the set of states comprises a historical time, a historical location, one or more historical features of the historical vehicle, and a supply-demand status of a historical area in which the historical vehicle was located. In some embodiments, the training process may include: for each of the plurality of historical trajectories, sequentially feeding the sets of states of the each historical trajectory and the corresponding historical supply-demand status in the plurality of neighboring areas of the historical vehicle to a neural network to obtain a predicted action value; and training the neural network based on the predicted action value and one of the plurality of actual action values.

FIG. 4B illustrates an exemplary method 420 for repositioning vehicles in a ride-hailing platform, in accordance with various embodiments. The method 420 may be implemented in an environment shown in FIG. 1A. The method 420 may be performed by a device, apparatus, or system illustrated by FIGS. 1A-3B, such as the system 102. Depending on the implementation, the method 420 may include additional, fewer, or alternative steps performed in various orders or in parallel.

With respect to the method 420 in FIG. 4A, at block 422, a plurality of first signals corresponding to a vehicle and a plurality of second signals corresponding to supply-demand status in a plurality of neighboring areas may be obtained. The plurality of first signals comprise a current time, a current location of the vehicle, and features of the vehicle. In some embodiments, the plurality of neighboring areas comprise a current area in which the vehicle is located.

At block 423, the plurality of first and second signals into a trained neural network may be input into a trained neural network to obtain a plurality of action values for repositioning the vehicle to the plurality of neighboring areas respectively.

At block 424, respective supply-demand gaps of the plurality of neighboring areas based on the supply-demand status in the plurality of neighboring areas may be determined. In some embodiments, the determining respective supply-demand gaps of the plurality of neighboring areas may include, for each of the plurality of neighboring areas: obtaining a total number of pending orders in the each neighboring area at a current time as a demand; obtaining a total number of idle vehicles in the each neighboring area at the current time as a supply; and determining a supply-demand gap of the each neighboring area based on the supply and the demand in the each neighboring area. The method 420 may further include: in response to the supply being equal to or greater than the demand, determining the supply-demand gap as a negative value; and in response to the supply being less than the demand, determining the supply-demand gap as a positive value.

At block 425, the plurality of action values may be updated based on the supply-demand gaps of the plurality of neighboring areas to obtain a plurality of updated action values. In some embodiments, the updating the plurality of action values based on the supply-demand gaps of the plurality of neighboring areas may include: for each of the plurality of neighboring areas, determining whether the corresponding supply-demand gap is greater than a threshold; and in response to the corresponding supply-demand gap being greater than the threshold, performing regularization on an action value corresponding to the each neighboring area based on the supply-demand gap.

At block 426, one of the plurality of neighboring areas for the vehicle to reposition to may be determined according to the plurality of updated action values.

At block 427, a signal may be transmitted to a computing device associated with the vehicle to reposition the vehicle to the one determined neighboring area.

In some embodiments, the method 420 may further include: determining, by the one or more computing devices based on the plurality of updated action values, a plurality of action-probabilities for repositioning the vehicle to the plurality of neighboring areas respectively, wherein the determining one of the plurality of neighboring areas for the vehicle to reposition to according to the plurality of updated action values comprises: performing unequal probability sampling from the plurality of neighboring areas based on the plurality of corresponding action-probabilities to obtain one sampled area for repositioning the vehicle to the one neighboring area. The determining the plurality of action-probabilities may include: inputting the plurality of updated action values into a softmax layer to obtain the plurality of action-probabilities, wherein the softmax layer is implemented as a block of computer programing code.

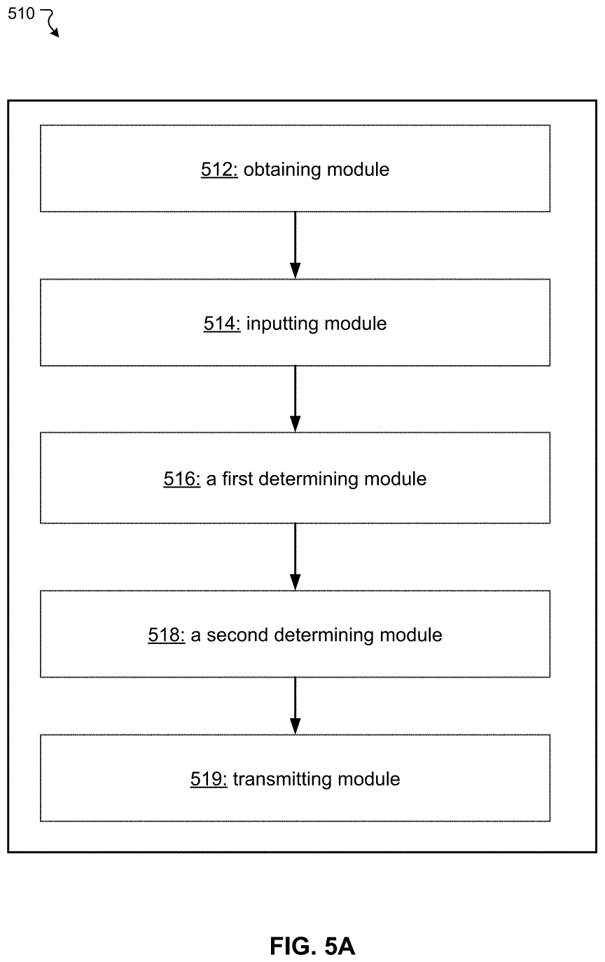

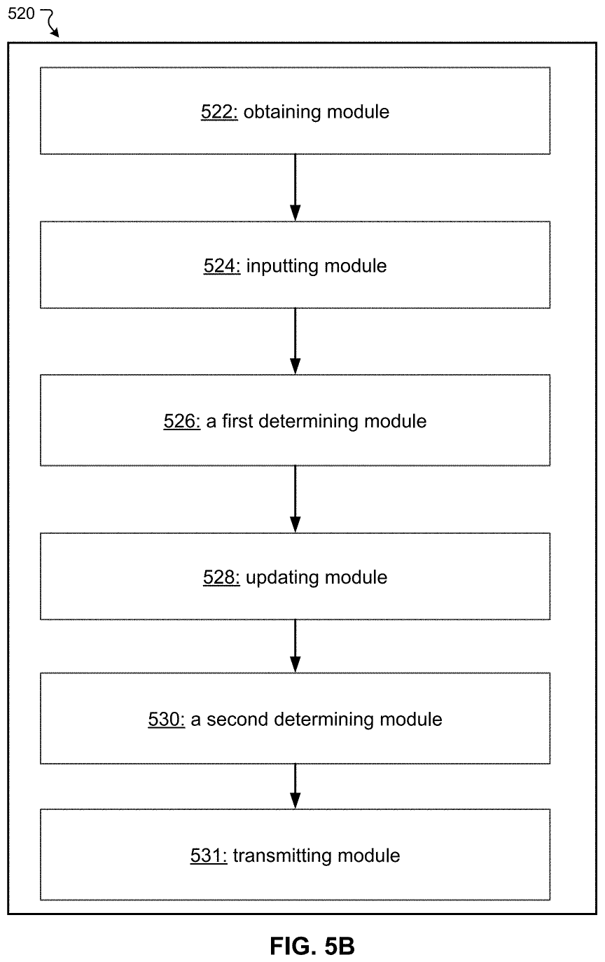

FIG. 5A illustrates an exemplary computer system 510 for repositioning vehicles in a ride-hailing platform, in accordance with various embodiments. The system 510 may be an exemplary implementation of the system 102 of FIG. 1A and FIG. 1B or one or more similar devices. The methods in FIGS. 4A and 4B may be implemented by the computer system 510. The computer system 510 may include one or more processors and one or more non-transitory computer-readable storage media (e.g., one or more memories) coupled to the one or more processors and configured with instructions executable by the one or more processors to cause the system or device (e.g., the processor) to perform the methods in FIGS. 4A and 4B. The computer system 510 may include various units/modules corresponding to the instructions (e.g., software instructions).

In some embodiments, the computer system 510 may include an obtaining module 512, an input module 514, a first determining module 516, a second determining module 518, and a transmitting module 519. The obtaining module 512 may be configured to obtain a plurality of first signals corresponding to a vehicle and a plurality of second signals corresponding to supply-demand status in a plurality of neighboring areas of the vehicle. The plurality of first signals comprise a current time, a current location of the vehicle, and features of the vehicle. The input module 514 may be configured to input the plurality of first and second signals into a trained neural network and obtain, from the trained neural network, a plurality of action values for repositioning the vehicle to the plurality of neighboring areas respectively. The first determining module 516 may be configured to determine, based on the plurality of action values, a plurality of probabilities for repositioning the vehicle to the plurality of neighboring areas respectively. The second determining module 518 may be configured to determine one of the plurality of neighboring areas for the vehicle to reposition to according to the plurality of probabilities. The transmitting module 519 may be configured to transmit a signal to a computing device associated with the vehicle to reposition the vehicle to the one determined neighboring area.

FIG. 5B illustrates another exemplary computer system 520 for repositioning vehicles in a ride-hailing platform, in accordance with various embodiments. The system 520 may be an exemplary implementation of the system 102 of FIG. 1A and FIG. 1B or one or more similar devices. The methods in FIGS. 4A and 4B may be implemented by the computer system 520. The computer system 520 may include one or more processors and one or more non-transitory computer-readable storage media (e.g., one or more memories) coupled to the one or more processors and configured with instructions executable by the one or more processors to cause the system or device (e.g., the processor) to perform the methods in FIGS. 4A and 4B. The computer system 520 may include various units/modules corresponding to the instructions (e.g., software instructions).

In some embodiments, the computer system 520 may include an obtaining module 522, an input module 524, a first determining module 526, an updating module 528, a second determining module 530, and a transmitting module 531. The obtaining module 522 may be configured to obtain a plurality of first signals corresponding to a vehicle and a plurality of second signals corresponding to supply-demand status in a plurality of neighboring areas. The plurality of first signals comprise a current time, a current location of the vehicle, and features of the vehicle. The input module 524 may be configured to input the plurality of first and second signals into a trained neural network and obtain, from the trained neural network, a plurality of action values for repositioning the vehicle to the plurality of neighboring areas respectively. The first determining module may be configured to determine respective supply-demand gaps of the plurality of neighboring areas based on the supply-demand status in the plurality of neighboring areas. The updating module 528 may be configured to update the plurality of action values based on the supply-demand gaps of the plurality of neighboring areas to obtain a plurality of updated action values. The second determining module 530 may be configured to determine one of the plurality of neighboring areas for the vehicle to reposition to according to the plurality of updated action values. The transmitting module 531 may be configured to transmit a signal to a computing device associated with the vehicle to reposition the vehicle to the one determined neighboring area.

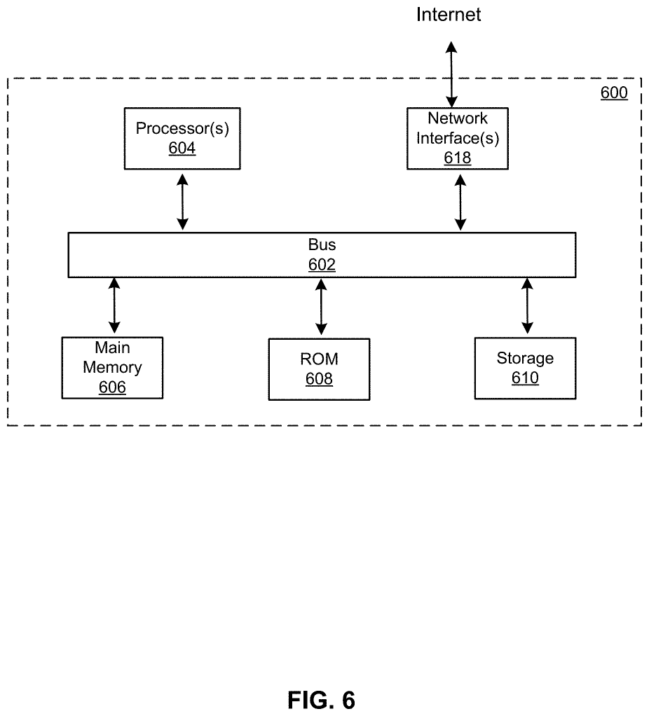

FIG. 6 is a block diagram that illustrates a computer system 600 upon which any of the embodiments described herein may be implemented. The system 600 may correspond to the system 190 or the computing device 109, 110, or 111 described above. The computer system 600 includes a bus 602 or another communication mechanism for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache, and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. The computer system 600 further includes a read-only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may implement the techniques described herein using customized hard-wired logic, one or more ASICs or FPGAs, firmware, and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The main memory 606, the ROM 608, and/or the storage 610 may include non-transitory storage media. The term “non-transitory media,” and similar terms, as used herein refers to a media that store data and/or instructions that cause a machine to operate in a specific fashion. The media excludes transitory signals. Such non-transitory media may include non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

The computer system 600 also includes a network interface 618 coupled to bus 602. Network interface 618 provides a two-way data communication coupling to one or more network links that are connected to one or more local networks. For example, network interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic, or optical signals that carry digital data streams representing various types of information.

The computer system 600 can send messages and receive data, including computer programming code, through the network(s), network link, and network interface 618. In the Internet example, a server might transmit a requested code for an application program through the Internet, the ISP, the local network, and the network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code modules executed by one or more computer systems or computer processors including computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be included in computer programming codes or instructions stored in a memory (e.g., a non-transitory computer-readable storage medium described above). Such algorithm may include a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS).

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method, comprising:
obtaining, by one or more computing devices, a plurality of first signals corresponding to a vehicle and a plurality of second signals corresponding to supply-demand statuses in a plurality of neighboring areas of the vehicle;
inputting, by the one or more computing devices, the plurality of first and second signals into a trained neural network and obtaining, from the trained neural network, a plurality of action values for repositioning the vehicle to the plurality of neighboring areas respectively;
determining, by the one or more computing devices, respective supply-demand gaps of the plurality of neighboring areas based on the supply-demand status in the plurality of neighboring areas;
updating, by the one or more computing devices, the plurality of action values based on the supply-demand gaps of the plurality of neighboring areas to obtain a plurality of updated action values;
determining, by the one or more computing devices according to the plurality of updated action values, one of the plurality of neighboring areas for the vehicle to reposition to; and
transmitting, by the one or more computing devices, a signal to a computing device associated with the vehicle to reposition the vehicle to the one determined neighboring area.

2. The method of claim 1, further comprising:
determining, by the one or more computing devices based on the plurality of updated action values, a plurality of action-probabilities for repositioning the vehicle to the plurality of neighboring areas respectively,
wherein the determining one of the plurality of neighboring areas for the vehicle to reposition to according to the plurality of updated action values comprises:
performing unequal probability sampling from the plurality of neighboring areas based on the plurality of corresponding action-probabilities to obtain one sampled area for repositioning the vehicle to.

3. The method of claim 2, wherein the determining the plurality of action-probabilities comprises:
inputting the plurality of updated action values into a softmax layer to obtain the plurality of action-probabilities.

4. The method of claim 1, wherein the updating the plurality of action values based on the supply-demand gaps of the plurality of neighboring areas comprises:
for each of the plurality of neighboring areas, determining whether the corresponding supply-demand gap is greater than a threshold; and
in response to the corresponding supply-demand gap being greater than the threshold, performing regularization on an action value corresponding to the each neighboring area based on the supply-demand gap.

5. The method of claim 1, wherein the determining respective supply-demand gaps of the plurality of neighboring areas comprises, for each of the plurality of neighboring areas:
obtaining a total number of pending orders for transportation in the each neighboring area at a current time as a demand;
obtaining a total number of idle vehicles providing transportation services in the each neighboring area at the current time as a supply; and
determining a supply-demand gap of the each neighboring area based on a difference between the supply and the demand in the each neighboring area.

6. The method of claim 5, further comprising:
in response to the supply being equal to or greater than the demand, determining the supply-demand gap as a negative value; and
in response to the supply being less than the demand, determining the supply-demand gap as a positive value.

7. The method of claim 1, wherein the plurality of neighboring areas comprise the current location of the vehicle.

8. The method of claim 1, further comprising:
training the neural network using a state-action-reward-state-action (SARSA) framework based on a plurality of historical trajectories of one or more historical vehicles, historical supply-demand statuses of a plurality of neighboring areas of the one or more historical vehicles, and a plurality of actual action values learned from historical data.

9. The method of claim 8, wherein each of the plurality of historical trajectories of a historical vehicle spans across a plurality of points in time, and comprises a set of states at each of the plurality of points in time, and
the set of states comprises a historical time, a historical location, one or more historical features of the historical vehicle, and a supply-demand status of a historical area in which the historical vehicle was located.

10. The method of claim 9, wherein the training comprises:
for each of the plurality of historical trajectories of the historical vehicle, sequentially feeding the sets of states of the each historical trajectory and the corresponding historical supply-demand status of the plurality of neighboring areas of the historical vehicle to a neural network to obtain an predicted action value;
training the neural network based on the predicted action value and one of the plurality of actual action values learned from the historical data.

11. The method of claim 1, wherein the plurality of first signals corresponding to a vehicle comprise:
a current time, a current location of the vehicle, features of the vehicle, and a supply-demand status of the current location of the vehicle.

12. The method of claim 1, wherein the plurality of second signals corresponding to supply-demand status in a plurality of neighboring areas comprise:
a supply-demand status of the current location of the vehicle; and
supply-demand status of one or more neighboring areas of the vehicle.

13. The method of claim 1, wherein the neural network comprises an attention module, and the method further comprises:
for a corresponding neighboring area, determining, through the attention module, a score based on a first supply-demand vector representing the supply-demand status of the current location of the vehicle and a second supply-demand vector representing the supply-demand status of the corresponding neighboring area;
applying the score to the second supply-demand vector to obtain a weighted supply-demand vector; and
generating a weighted supply-demand context vector based on the plurality of weighted supply-demand vectors respectively corresponding to the plurality of neighboring areas.

14. The method of claim 1, wherein the determining one of the plurality of neighboring areas for the vehicle to reposition to comprises:
performing unequal probability sampling from the plurality of neighboring areas based on the plurality of probabilities to obtain one sampled area.

15. A system comprising one or more processors and one or more non-transitory computer-readable memories coupled to the one or more processors, the one or more non-transitory computer-readable memories storing instructions that, when executed by the one or more processors, cause the system to perform operations comprising:
obtaining a plurality of first signals corresponding to a vehicle and a plurality of second signals corresponding to supply-demand statuses in a plurality of neighboring areas of the vehicle;
inputting the plurality of first and second signals into a trained neural network and obtaining, from the trained neural network, a plurality of action values for repositioning the vehicle to the plurality of neighboring areas respectively;
determining respective supply-demand gaps of the plurality of neighboring areas based on the supply-demand status in the plurality of neighboring areas;
updating the plurality of action values based on the supply-demand gaps of the plurality of neighboring areas to obtain a plurality of updated action values;
determining, according to the plurality of updated action values, one of the plurality of neighboring areas for the vehicle to reposition to; and
transmitting a signal to a computing device associated with the vehicle to reposition the vehicle to the one determined neighboring area.

16. The system of claim 15, the operations further comprising:
determining, based on the plurality of updated action values, a plurality of action-probabilities for repositioning the vehicle to the plurality of neighboring areas respectively,
wherein the determining one of the plurality of neighboring areas for the vehicle to reposition to according to the plurality of updated action values comprises:
performing unequal probability sampling from the plurality of neighboring areas based on the plurality of corresponding action-probabilities to obtain one sampled area for repositioning the vehicle to.

17. The system of claim 16, wherein the determining the plurality of action-probabilities comprises:
inputting the plurality of updated action values into a softmax layer to obtain the plurality of action-probabilities.

18. A non-transitory computer-readable storage medium storing instructions that, when executed by one or more processors, cause the one or more processors to perform operations comprising:
obtaining a plurality of first signals corresponding to a vehicle and a plurality of second signals corresponding to supply-demand statuses in a plurality of neighboring areas of the vehicle;
inputting the plurality of first and second signals into a trained neural network and obtaining, from the trained neural network, a plurality of action values for repositioning the vehicle to the plurality of neighboring areas respectively;
determining respective supply-demand gaps of the plurality of neighboring areas based on the supply-demand status in the plurality of neighboring areas;
updating the plurality of action values based on the supply-demand gaps of the plurality of neighboring areas to obtain a plurality of updated action values;
determining, according to the plurality of updated action values, one of the plurality of neighboring areas for the vehicle to reposition to; and
transmitting a signal to a computing device associated with the vehicle to reposition the vehicle to the one determined neighboring area.

19. The non-transitory computer-readable storage medium of claim 18, wherein the determining respective supply-demand gaps of the plurality of neighboring areas comprises, for each of the plurality of neighboring areas:
obtaining a total number of pending orders for transportation in the each neighboring area at a current time as a demand;
obtaining a total number of idle vehicles providing transportation services in the each neighboring area at the current time as a supply; and
determining a supply-demand gap of the each neighboring area based on a difference between the supply and the demand in the each neighboring area.

20. The non-transitory computer-readable storage medium of claim 18, wherein the operations further comprise:
training the neural network using a state-action-reward-state-action (SARSA) framework based on a plurality of historical trajectories of one or more historical vehicles, historical supply-demand statuses of a plurality of neighboring areas of the one or more historical vehicles, and a plurality of actual action values learned from historical data.
